(19) United States
(12) Patent Application Publication
(10) Pub. No.: US 2004/0255433 A1
(43) Pub. Date: Dec. 23, 2004

(54) Paper clip

(76) Inventor: Arsenio P Santos JR., Aloha, OR (US)

Correspondence Address: PETER A. HAAS, ESQUIRE, 1929 SW 13TH AVENUE, PORTLAND, OR, 97201, US

(21) Appl. No.: 10/502,738

(22) PCT Filed: Jan. 31, 2003
(86) PCT No.: PCT/US03/02966

Related U.S. Application Data
(60) Provisional application No. 60/353,402, filed on Feb. 1, 2002.

(51) Int. Cl. B42F 1/02

(52) U.S. Cl. 24/67.9

(57) ABSTRACT

A novel paper clip with a substantially planar profile, with an arrangement of structures that, among other things, reduces the risk of tearing paper, grips paper more securely, is less likely to entangle with other clips, and is more efficient to use and longer lasting.

This invention claims the benefit of co-pending U.S. Provisional Application No. 60/353,402, entitled AN IMPROVED PAPER CLIP, filed on Feb. 1, 2002, the entire disclosure of which is hereby incorporated by reference as if set forth in its entirety for all purposes.

### BACKGROUND OF THE INVENTION

This invention relates to binders for stacked paper and specifically to paper clips made from a single length of rigid material with some degree of resilience.

Paper clips have been around for more than a century, and the commonest form commercially available is not necessarily the best but mainly the cheapest, according to popular observation. There is a pervading need to improve on the current design. The conventional double oval design, also known as the gem clip, has been especially targeted for improvements by inventors the world over. However, it is still perceived to be the best compromise of all the desirable qualities even though it has its share of design problems, which until the present invention have not been adequately overcome by those attempting improvements. Accordingly there is a substantial need for an improved paper clip that has the one or more of the following qualities: strong gripping power; low risk of ripping or tearing papers; will not tangle up with other paper clips in the box; easy and comfortable to use; will not fly off when made to engage thicker stacks of papers; better holding capacity relative to raw materials used; free from risk of physical injury; allows more options for manufacturing different sizes; repeat usability especially for bigger size clips; aesthetically pleasing design; cheap and easy to manufacture.

Among the disadvantages of a conventional clip such as the gem clip is the clip's propensity for tearing papers while being removed. This problem arises because the free ends of the clip are set at a lower position. This becomes more significant with the smaller size paper clips in which are the free ends are set even much lower.

Specific attempts have been made to overcome this shortcoming. For example, U.S. Pat. No. 5,329,672 discloses a large gem clip having preferred dimensions of three (3) inches to five (5) inches in overall length. Of particular interest is the length of the free ends, which extend beyond a tangent point on the closed loop portion. However, this design has several shortcomings. For instance, the relatively long gripping jaws reduce gripping force. This is compensated by both increasing the overall length and increasing the cross-sectional (or heavier gauge) diameter of the resilient material The increase in overall length provides increased frictional contact area, while the increased cross-sectional area of the wire increases the resiliency of the material. This solution is wasteful, as the need for additional raw materials are required to attain satisfactory gripping properties.

Other known problems with conventional clips are their tendency to unexpectedly and suddenly release as a user attempts to engage it with thicker stacks of papers. This may subject the user to eye injury or other discomfort. Also, a stack of paper just a few pages thick may permanently deform the prior art clips beyond their resilient threshold. This may render the clip ineffective at retaining the paper or otherwise destroy its usability.

Apparently nothing in the market today has a better mix of the desirable qualities. Thus, the gem paper clip continues to enjoy its dominance in the market. The solution chosen by some manufacturers is to produce a cloned type of gem clip by economizing on raw materials. However, as the price becomes all the more a determining factor in sales, the more undesirable the prior-art clip becomes. This practice has resulted in the proliferation of many poor quality gem clips in the market today.

Several attempts have been made over the years to improve the paper clip. One such attempt is to strengthen the grip by increasing frictional contact. U.S. Pat. No. 2,269,649 to Comley (1942) makes use of elongated loop-shaped jaws (identified by reference numbers 7, 9 in the '649 patent), to achieve this goal. However, by elongating the inner loop shaped jaw 9, the free end portion 11 is extended further upward which would make it difficult to open the clip during insertion. This is a trade off for a desired stronger grip. Consequently in order to meet this new problem a laterally offset compound curvature is needed, resulting in a clip that is not flat. This structure, although intended mainly to reduce tearing, could explain the claim of the inventor that the overall configuration of his design provides for ease of use. The added structure however triggers a new problem for which there was no answer undertaken. The laterally offset compound curvature sticks out during use (FIG. 4, '649 patent). According to the teaching of this invention, this structure is displaced as the stacks of paper becomes thicker. In this manner, tears can be prevented. But, as the structure is displaced, its tip 8 presents problems concerning risk for physical injury to the user or anyone close by. Additionally, this design is wasteful. Another problem of this design would be the tendency of the protruding structures 8 and 11 to catch unintended objects while in use and the enhanced proclivity to get tangled up with other paper clips in the box.

The prior art also discloses triangle-shaped clips in attempt to solve some shortcomings of the gem clip. Triangle-shaped clips usually have free ends that are close to the top spine or connector. This can be seen in U.S. Pat. No. 761,631 to Gorton (1904), U.S. Pat. No. 767,458 to Weiss (1904), U.S. Pat. No. 761,635 to Kelley (1904), U.S. Pat. No. 1,336,626 to Hall (1920) and U.S. Pat. No. 1,985,866 to Lankenau (1934). The triangular configuration can reduce the tendency to rip papers, but it is not easy to use. The extended free ends deprive the top spine from acting as a handle to urge open the clips when attempting to engage papers. Furthermore the above designs share in common the presence of a central gap or space. The index finger or thumb can slip through this gap making manipulation more difficult during insertion. As a result they are usually manufactured in smaller sizes such that the index finger or thumb will not pass through.

### SUMMARY OF THE INVENTION

The present invention overcomes the problem in the prior art by providing a novel paper clip with the following qualities, alone or in combination:

1. Improved gripping power in proportion to raw material used.

2. Elimination or reduced risk of tearing or ripping of sheets of papers.

3. Elimination or reduced risk of tangled paper clips in a container.

4. Improved manipulability during use.

5. Minimized risk of metal fatigue from repeated use through reversible insertion mode.

6. Improved stable feel and comfort in handling by incorporating a gap catch.

7. Improved flexibility in manufacture sizing.

8. Reduced risk of wrong end insertion through visual and tactile design recognizability.

9. Improved aesthetics.

10. Improved planarity by providing a more flatly engaged paper clip when holding more sheets of papers.

11. Improved compactness and sturdiness in a single plane construction.

12. Improved ease of use.

13. Improved safety.

14. Reduction in raw material for a given capacity of sheets of paper.

In the prior art, the conventional thinking is that the longer the arms of paper clips, the stronger the grip because of more frictional surface contact. The present invention is based on the surprising and unexpected finding by the inventor that the more significant factor is not the frictional surface contact but the length of the gripping jaws as well as the length of torsion bridge both of which are inversely related to the effective gripping force. Furthermore, the gripping force is also inversely related to the distance between the inner and outer arms. Quite opposite the conventional thinking, this novel invention shows that the shorter gripping jaws (which equates to shorter lever arm albeit less frictional contact) effectively reduces the resisting force a collection of sheets of paper can exert against the jaws. Thus, the propensity to release the hold of the clip is greatly reduces, while simultaneously increasing the gripping force of the cooperating jaws.

Therefore, by optimizing the relationship of the torsion bridge to the length of the outer and inner jaws, significant gains can be made in gripping force, while simultaneously reducing the required amount of raw material.

The present invention may be made of any material from which conventional paper clips are made. Paper clips, according to the present invention, preferably are made of a unitary piece of material bended or molded to a desired configuration. Both wire and plastic materials are contemplated. The profile of the cross-section may be round, rectilinear, twisted, or any other known or desired configuration. To enhance frictional grip, it may be desired to use a twisted configuration or other such configuration that enhances frictional contact with the paper.

By balancing the need for capacity (increasing the length of the torsion bridge) against the need for gripping force (decreasing the length of the gripping jaws), the present invention optimizes raw material use and provides superior gripping force, when compared with a similar capacity clip of the prior art.

Of notable interest, the present invention comprises cooperating jaws, however the entire device lies in a single plane. One significant advantage of planarity is that the clip is reversible, i.e., it clips paper from either side. Therefore, with both sides being used there is less metal fatigue. It also reduces application time by fifty-percent because the user does not need to reorient the paper clip to the functional side. There is also less stacking bulk because of the planarity.

The present invention's use is not limited to paper sheets, but may also be used with other sheet-like material, such as plastic sheets.

### BRIEF DESCRIPTION OF THE DRAWINGS

FIG. 1 is plan view of a paper clip in accordance with the present invention.

FIG. 2 is a right side elevational view of a the paper clip of FIG. 1

FIG. 3 is a left side elevational view of the paper clip if FIG. 1.

FIG. 4 is top elevational view of the paper clip of FIG. 1.

FIG. 5 is bottom elevational view of the paper clip of FIG. 1.

FIG. 6 is another possible embodiment of a paper clip in accordance with the present invention.

FIG. 7 is plan view of another possible embodiment of a paper clip in accordance with the present invention.

FIG. 8 is a plan view of another possible embodiment of a paper clip in accordance with the present invention.

FIG. 9 is a plan view of another possible embodiment of a paper clip in accordance with the present invention.

FIG. 10a is plan view of another possible embodiment of a paper clip in accordance with the present invention.

FIG. 10b is side view of the embodiment of FIG. 10a

FIG. 10c is a top view of the embodiment of FIG. 10a

FIG. 10d is a bottom view of the embodiment of FIG. 10a

FIG. 10e is a plan view of an embodiment of a bookmark in accordance with the present invention.

FIG. 10f is a plan view of another possible embodiment of a bookmark in accordance with the present invention.

FIG. 11a is plan view of a paper clip in accordance with the present invention.

FIG. 11b is top elevational view of the paper clip of FIG. 11a.

FIG. 12a is plan view of a paper clip in accordance with the present invention.

FIG. 12b is plan view of a paper clip in accordance with the present invention.

### DETAILED DESCRIPTION OF THE INVENTION

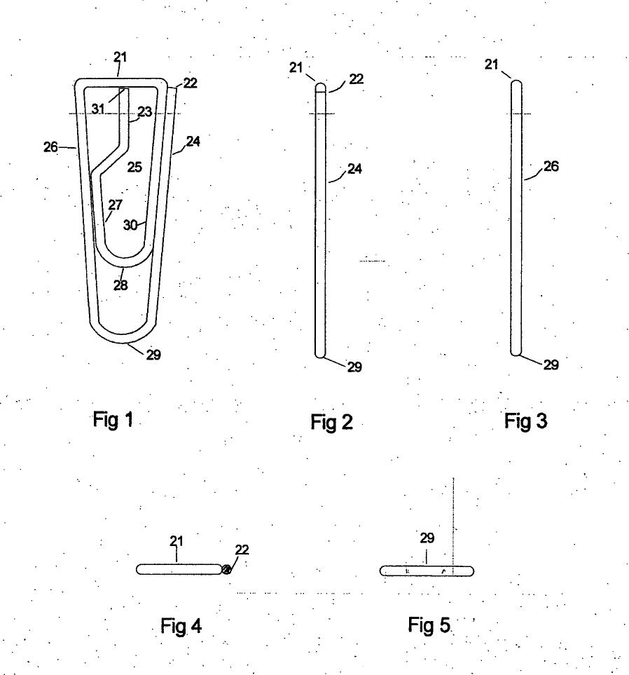

FIGS. 1-12 show embodiments of the present invention in accordance with the foregoing principles. Similar features are indicated by the same reference numeral. The present invention is generally indicated by the reference numeral 1.

The paper clip 1 generally comprises a torsion bridge 21, a gap catch 23, an inner jaw 28, and an outer jaw 29. Preferably, the inner and outer jaws 28, 29 and the torsion bridge 21 are in the same or substantially in the same plane. Torsion bridge 21 is disposed at the top of the clip. Inner jaw 28 includes, a closed inner arm 30 and an open inner arm 27. The torsion bridge 21 may be straight curved or other configuration spanning outer arm 26 and inner arm 30. The torsion bridge 21 may include a first bend 40. Outer jaw 29, has a rounded end, and includes an open outer arm 24, an outer arm free end 22, and a closed outer arm 26. The inner jaw may include a second bend 41 and the outer jaw may include a third bend 42. Leading downwardly from the left side of the torsion bridge 21 and integral therewith is closed outer arm 26. Leading downwardly from the right side is open outer arm 24. Gap catch free end 31 is disposed at the end of open inner arm 27, substantially filling up the central gap 25 of the clip. It terminates at free end 31. The gap catch 23 can be urged from either direction by any of two opposing fingers. The outer jaw 29 is sufficiently distanced from the inner jaw 28 to promote cooperation with the gap catch 23 during insertion of paper. The outer arm 24 is adjacent to the closed inner arm 30. Closed outer arm 26 is adjacent to open inner arm 27 but may be spaced apart as in alternative embodiments. In a suitable embodiment, the outer jaw open arm 24 and the inner jaw closed end 31 are spaced apart not more than a cross-sectional diameter of width of the clip material.

Preferably sections 24 and 30 are closely adjacent. The closely adjacent sections 24 and 30 eliminate gaps that could lead to paper clips 1 entangling with one another. In a suitable embodiment the gap would typically be less than a full diameter of the material, for example between 0 and 85% of the cross sectional diameter of a round cross sectional material. The inner jaw closed end 30 and the outer jaw open end 24 each have a segment whereby each respective segment is closely adjacent to the other. These segments are substantially coplanar. In a suitable embodiment, the ends 24 and 20 are in contact. In another embodiment the ends 24 and 30 are within 3 mm.

The planarity of the clip 1 also helps in reducing the tendency of multiple clips 1 to tangle with one another. Preferably, end 31 should be closely adjacent or touching torsion bridge 21 to close gaps that could lead to entanglement. Further, such an arrangement serves to reduce risk of tearing paper because the end is located at the edge of paper. Still further, this arrangement reduces the risk of physical injury to fingers by placing the ends out of the finger contact regions. Still further, the location of the gap catch between outer arm 26 and inner arm 30 helps stabilize the paper clip 1 against lateral displacement during use.

The paper clip 1 is employed over paper by slightly pressing the gap catch 23 to create an opening for receiving paper. This makes it possible to locate the inner arm 27 closer to the torsion bridge 21. The gap catch 23 is generally offset from the outer jaw 29. In one suitable embodiment, the gap catch 23 extending from the inner jaw 28 at one end is placed diagonally across a void defined by the shape of the inner jaw 28. In another suitable embodiment, the gap catch may include a bend at an intermediate portion, thus extending from the inner jaw 28, and then proceeding generally parallel to the outer jaw 29. At the bend in the intermediate portion, the gap catch 23 would then extend away from the outer jaw 29 at the gap catch free end 31.

In one possible embodiment, gap catch free end 31 could extend to the torsion bridge 21. This, for example, could be done in plastic, producing a stronger plastic version, compensating for the generally less resilient nature of plastics relative to metals.

Paper clips according to the present invention may be manufactured and used in a wide range of sizes. They also may be effectively used at a size where conventional clips are not effective because they are hard to manipulate at the size range or are prone to deformation. For example, conventional clips of about 2.0″ long and about 0.25″ wide, which is generally the most common size for a conventional clip, have an effective capacity of about 12 pages. Beyond that number the arms of the clip tend to twist away from the surface of the pages. In contrast, a paper clip according to the present invention that is 0.75-1″ long and 0.5-0.75″ wide could hold effectively about 24-36 pages, thereby obviating the need for larger and/or more expensive clipping devices such as butterfly clips or binder clips.

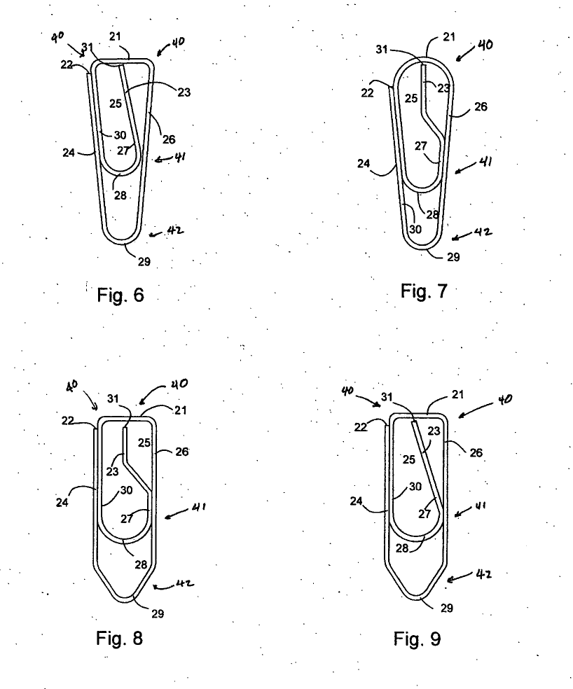

In FIG. 6, open inner arm 27 and gap catch 23 are disposed substantially in linear alignment. The linear arrangement is disposed at an acute angle relative to the longitudinal axis of the clip. The embodiment of FIG. 7 is similar to the embodiment of FIG. 1 but with a rounded top portion. The embodiment of FIG. 8 is similar to FIG. 1, but has a triangularly shaped end to outer jaw 29. The embodiment of FIG. 9 is similar to the embodiment of FIG. 6 but, inner arm 27 and gap catch 23 are in linear arrangement. It is noted that the use of a triangular top and/or bottom may use less material than the rounded version. It is also advantageous to have a general shape with downwardly converging jaw portions 28 and 29, as shown in FIGS. 1 and 6, for example. This converging design allows for less raw material during manufacture. It also reduces the likelihood of the lower portion of the clip 1 deforming away from paper, particularly where the clip 1 is used on thicker stacks of paper. The triangular bottom portion of, for example, FIGS. 8 and 9 also help produce the foregoing effects.

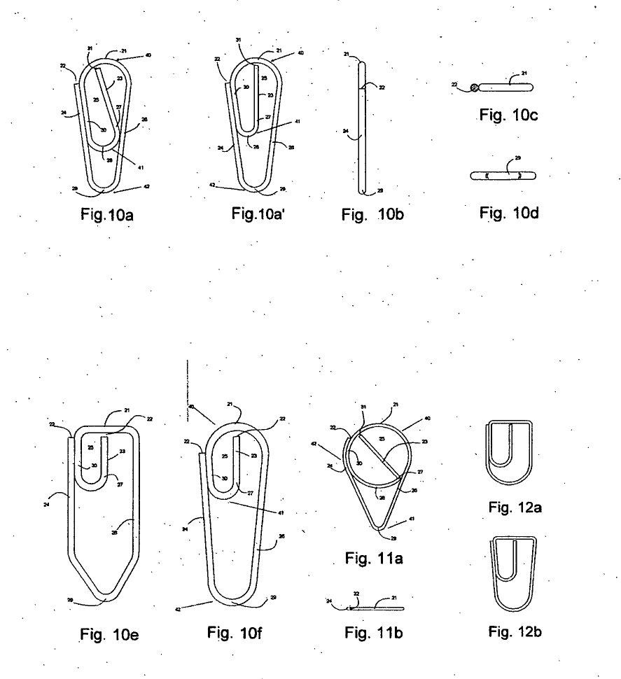

Referring specifically to FIGS. 10a, 10b, 10c, and 10d, a suitable embodiment of the present invention is shown which includes three bends. In this embodiment, the clip 1 is an economical configuration that facilitates manufacturing of the invention. As shown, a continuous length of resilient material, such as plastic, wire, spring wire, or other material known in the art, is formed in to the clip 1 of the present invention. Starting at the outer arm free end 22, a straight length of material extends therefrom, forming the open outer arm 24. A first bend is included on the outer jaw 29 at a location on the open outer arm 24. The location of the bend occurs at a point that facilitates economy of production, while optimizing a selected capacity of the clip 1. The first bend continues to round the outer jaw 29 and begins to form closed outer arm 26 at one end. At a second end of the closed outer arm 26, a second bend transitions from the closed outer arm 26 to the torsion bridge 21. The torsion bridge 21 in this embodiment is formed from a uniform diameter, which is selected based on the capacity requirements of a desired clip 1. The second bend comprises the transition from the closed outer arm 26 at one end to the closed inner arm 30 at an opposite end of the continuous length of resilient material. Extending from the torsion bridge 21, the closed inner arm 30 generally follows a path parallel to the open outer arm 24. It is understood that the inner closed arm 30 cooperates with the open outer arm 24 to define a inner closed end gap 35.

In FIG. 10a, this gap 35 is quite narrow, and contributes to the gripping force of the cooperating outer jaw 29 and inner jaw 28. However, in FIGS. 11 and 12, an alternate embodiment is shown where the gap 37 is quite large, resulting in low gripping force. In FIGS. 11 and 12, a suitable use for such an embodiment is a bookmark or other application where low gripping force is desired.

Returning to a general description of FIGS. 10a, 10b, 10c, 10d, 11 and 12, the inner closed arm 30 is connected to the torsion bridge 21 and second bend at one end. At an opposite end, the inner closed arm 30 communicates with a third bend, here the inner jaw 28. A third bend, which is included on the inner jaw 28, may be one continuous constant diameter. In this manner the third bend and inner jaw 28 transition to the open inner arm 27. It should be noted that the open inner arm 27 traverses a void defined by the inner jaw 29 cooperating with the closed inner arm 30 and closed outer arm 26. In FIG. 10a the open inner arm 27 extends at a general diagonal direction from the inner jaw 28 toward the outer arm free end 22. In this manner, the open inner arm 27 terminates at the gap catch free end 31 and cooperates with the torsion bridge 21 to create a narrow inner free end gap 33. This gap 33, in a suitable embodiment, is less than the cross sectional diameter of the resilient material so to reduce the propensity of multiple clips 1 from tangling during handling, shipping, storage and the like.

Referring again specifically to FIGS. 1-9 and 10a, it is shown that the open inner arm 27 cooperates with the closed outer arm 26 at a point near the inner jaw 28 and the third bend to create a small inner jaw gap 37. This small inner jaw gap 37 reduces the propensity of multiple clips 1 from tangling during handling, shipping, storage and the like. Additionally, this inner jaw gap 37 contributes to the gripping force of the clip 1, making the force greater.

Conversely, referring now to FIGS. 11 and 12, the inner jaw gap 37 is relatively broad. This results in a lower gripping force, and may be useful for a bookmark or other applications where lower gripping force is desired.

Surface friction created by increasing the contact area of the jaws 28, 29 to the stack of sheet material, such as paper, contrary to conventional thinking, plays less important role. More significantly, the ability to firmly grasp a stack of paper depends more on the gripping force exerted on the papers by decreasing the length of the inner and outer arms of jaws 28, 29 respectively. Of course, it is understood that, if a point is reached where the contact area becomes too small no amount of gripping force can make the paper clip hold pages effectively. Thus, an important ratio of gripping force to the overall length of the gripping arms is established.

Specifically, gripping force is related to the combination of the amount of resistive force inherent in the resilient material when twisted about its own axis. The nexus of this resistive force occurs at the torsion bridge 21 and transfers the force along the closed outer arm 26 and closed inner arm 30. It is understood, that by maintaining relatively short gripping jaws 28 and 29, the counter acting leverage force exerted by a quantity of sheet material is reduced. This counter acting leverage force works to separate the inner and outer jaw 28 and 29, thus reducing the gripping force. It should also be understood in the art that too short of a gripping jaw will result in no gripping force.

Capacity, as measured by the number of sheets of paper that can be grasped by the paper clip 1, is directly proportional to the arc length. It is understood that the torsion bridge 21 can be configured to be curved over any suitable radius. In the extreme, but suitable, configuration, the torsion bridge 21 may be straight, or otherwise defined as have a radius of 180 degrees.

It is understood in the art that it is desired to form the present invention from a resilient material. Such a material is suitable for items such as paper clips and has desirable characteristics, for example, the ability to be initially formed to a desired shape, then retain that shape after repeated deformations within normal use.

However, as the gripping jaws 28 and 29 decrease in overall length, the more difficult it becomes to manipulate and insert paper into gripping jaws 28 and 29 of the clip. To compensate for this difficulty, this invention incorporates the feature of a gap catch 23. The gap catch 23 permits a user to exert a pressure on the clip 1 to separate the jaws 28 and 29, thus facilitating easy insertion of paper. I have discovered that a gap catch 23 that is formed by the open arm 27 of the inner jaw 28 is canted so to traverse an inner space region of the inner jaw 28 at a generally diagonal direction facilitates user manipulation. Moreover, this design does not adversely affect the gripping force of the clip.

Another important aspect of this invention is the small or non-existent gaps between the inner jaw and the outer jaw particularly along the side of the outer free arm. This prevents tangling of clips when a plurality of the clips is stored. Additionally, it also enhances the gripping force and reduces the tendency of the clip to tear paper when used.

Additionally, by maintaining small or no gaps at the free ends in relation to the clip structure, there is a reduced propensity to tear paper and become entangled.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

What is claimed:

1. A clip comprising:
a torsion bridge linking an inner jaw and an outer jaw; the torsion bridge, inner jaw and outer jaw cooperating to receive and retain one or more sheets of material; the inner jaw further including a gap catch extending from a closed end of the inner jaw whereby the gap catch is disposed in a generally offset position in relation to the outer jaw and wherein one end of the gap catch is closely adjacent to a portion of the torsion bridge.

2. The clip of claim 1 wherein the inner jaw and the outer jaw and the torsion bridge are substantially coplanar.

3. The clip of claim 1 wherein the offset is formed by disposing the gap catch in a generally diagonal direction relative to the outer jaw.

4. The clip of claim 1 wherein the gap catch has a first portion that is generally parallel to the outer jaw and further comprises a bend at an intermediate position so as to cause a second end of the offset to be disposed toward a central void area defined by the inner jaw wherein the gap catch is positioned to enable ease of use.

5. The clip of claim 1 further comprising three bends, the torsion bridge including a first bend, the inner jaw including a second bend, and the outer jaw including a third bend.

6. A clip comprising:
a torsion bridge linking an inner jaw and an outer jaw; the torsion bridge, inner jaw and outer jaw cooperating to receive and retain one or more sheets of material;
the torsion bridge including a length defined as the distance between a closed outer arm of the outer jaw and a closed inner arm of the inner jaw;
a gap catch extending from a closed end of the inner jaw and terminating at a gap catch free end wherein the gap catch free end is closely adjacent to a portion of the torsion bridge; and
the overall length of the closed outer arm being dimensioned in a ratio with the length of the torsion bridge, the ratio being about 3 units of measure of length to about 1 to 2 units of measure of the length of the torsion bridge.

7. The clip of claim 6 wherein the torsion bridge is generally arcuate in shape.

8. The clip of claim 6 wherein the torsion bridge is generally linear.

9. The clip of claim 6 further comprising three bends, the torsion bridge including a first bend, the inner jaw including a second bend, and the outer jaw including a third bend.

10. A clip for a sheet material comprising:
a torsion bridge linking an inner jaw and an outer jaw; the torsion bridge, inner jaw and outer jaw cooperating to receive and retain one or more sheets of material; the inner jaw further including a gap catch extending from a closed end of the inner jaw, the gap catch being disposed in a generally offset position in relation to the outer jaw, one end of the gap catch being closely adjacent to a closed end of the outer jaw;
the inner jaw having an inner jaw open arm having a free end, the free end and the torsion bridge being closely adjacent so as to avoid or minimize engagement of the free end with the sheet material; and
the outer jaw having an outer jaw open arm having an outer jaw free end, the outer jaw free end being generally adjacent to the torsion bridge, the outer free end being so positioned to minimize engagement of the free end with the sheet material.

11. The clip of claim 10 wherein the inner jaw free end is spaced apart not more than about a cross sectional diameter of width of the clip material in the torsion bridge or free end.

12. The clip of claim 10 further comprising three bends, the torsion bridge including a first bend, the inner jaw including a second bend, and the outer jaw including a third bend.

13. A clip formed from a resilient material comprising:
a torsion bridge linking an inner jaw and an outer jaw; the torsion bridge, inner jaw and outer jaw cooperating to receive and retain one or more sheets of material; the inner jaw including a gap catch extending from a closed end of the inner jaw, the gap catch being disposed in a generally offset position in relation to the outer jaw, one end of the gap catch being closely adjacent to a closed end of the outer jaw;
the inner jaw including an inner jaw closed arm, an inner jaw open arm, and a gap catch, the gap catch being disposed in a generally offset position in relation to the outer jaw, the inner jaw open arm having a free end, the free end and the torsion bridge being spaced apart not more than about a cross sectional diameter of width of the clip material in the torsion bridge or free end; and
the outer jaw including an outer jaw closed arm and an outer jaw open arm, the outer jaw open arm having a free end, the free end being closely adjacent to the torsion bridge, the open arm free end and torsion bridge being closely adjacent so as to avoid or minimize engagement with the sheet material; and
wherein the outer jaw open arm are spaced apart not more than about a cross sectional diameter of width of the clip material.

14. The clip of claim 13 wherein the inner jaw and outer jaw and torsion bridge are substantially coplanar.

15. The clip of claim 13 further comprising three bends wherein the torsion bridge further comprises a first bend to define an arc length.

16. The clip of claim 13 further comprising three bends, the torsion bridge including a first bend, the inner jaw including a second bend, and the outer jaw including a third bend.

17. The clip of claim 13 wherein the open arm free end is closely adjacent to the torsion bridge so as not to be spaced apart not more then 3 mm apart therefrom.

18. A clip for sheet material comprising: a torsion bridge linking an inner jaw and an outer jaw; the torsion bridge, the inner jaw and outer jaw cooperating to receive and retain one or more sheets of material; the inner jaw including a gap catch extending from a closed end of the inner jaw, the gap catch being disposed in a generally offset position in relation to the outer jaw and wherein one end of the cap catch is closely adjacent to a portion of the torsion bridge; the inner jaw including an inner jaw closed arm and an inner jaw open arm; the outer jaw including an outer jaw closed arm and an outer jaw open arm; the outer jaw open arm and the inner jaw closed arm being closely adjacent along at least a segment of the clip and the outer jaw closed arm being closely adjacent along at least a segment of the clip, the adjacent segments being substantially coplanar.

19. The clip of claim 6 wherein the outer and inner jaws are substantially coplanar.

20. The clip of claim 17 one wherein the closely adjacent arms or both segments are not spaced apart more than about the crossectional diameter or width of a material forming the clip in the segment.
